(19) United States
(12) Patent Application Publication
(10) Pub. No.: US 2025/0030061 A1
(43) Pub. Date: Jan. 23, 2025

(54) PRESSURE CONTROL OF BATTERY CELLS

(71) Applicant: GM Global Technology Operations LLC, Detroit, MI (US)

(72) Inventors: Jun-mo Kang, Ann Arbor, MI (US); Hanho Yun, Oakland Township, MI (US); Chen-fang Chang, Bloomfield Hills, MI (US); Insu Chang, Troy, MI (US); Yongjie Zhu, Troy, MI (US); Chunhao J. Lee, Troy, MI (US)

(21) Appl. No.: 18/354,782

(22) Filed: Jul. 19, 2023

(51) Int. Cl. H01M 10/42

(52) U.S. Cl. CPC H01M 10/4235; H01M 2200/20; H01M 2220/20

(57) ABSTRACT

A pressure management system includes a pressure plate disposed at an initial position relative to a battery cell, the battery cell disposed in a housing, where expansion of the battery cell causes an expansion force to be applied to the pressure plate. The pressure management system also includes a mechanical linkage attached to the pressure plate, the mechanical linkage configured to move in a lateral direction in response to the expansion force and translate the expansion force to a reactive force that is opposed to the expansion force, and a biasing system including a biasing member configured to resist lateral movement of the mechanical linkage. The biasing system is configured to apply a biasing force in a direction opposite the lateral direction, the biasing force causing the mechanical linkage to apply the reactive force as a selected proportion of the expansion force.

### INTRODUCTION

The subject disclosure relates to battery systems, and more particularly to managing pressure of battery cells of a battery system.

Battery pouch cells are used in various applications, such as automotive applications (e.g., in electric and hybrid vehicles). For example, electric and hybrid vehicles include battery systems that include battery packs that house multiple battery cells, which may include pouch type cells such as lithium-ion cells. As such cells charge and discharge, and as such cells age, the pressure can change, which can be detrimental to the charging and power storage capability. It is desirable to provide mechanisms that maintain battery cells at a substantially constant pressure over their operating lifetimes.

### SUMMARY

In one exemplary embodiment, a pressure management system includes a pressure plate disposed at an initial position relative to a battery cell, the battery cell disposed in a housing, where expansion of the battery cell causes an expansion force to be applied to the pressure plate. The pressure management system also includes a mechanical linkage attached to the pressure plate, the mechanical linkage configured to move in a lateral direction in response to the expansion force and translate the expansion force to a reactive force that is opposed to the expansion force, and a biasing system including a biasing member configured to resist a lateral movement of the mechanical linkage. The biasing system is configured to apply a biasing force in a direction opposite the lateral direction, the biasing force causing the mechanical linkage to apply the reactive force as a selected proportion of the expansion force.

In addition to one or more of the features described herein, the biasing member has a spring constant selected so that the biasing force causes the reactive force to be the selected proportion of the expansion force.

In addition to one or more of the features described herein, the system includes a stop component configured to restrict the lateral movement of the mechanical linkage, the reactive force generated based on the stop component causing a portion of a lateral force generated by the mechanical linkage to be directed toward the battery cell.

In addition to one or more of the features described herein, the biasing member is a spring having a first end configured to be coupled to the mechanical linkage, and a second end connected to the stop component.

In addition to one or more of the features described herein, the mechanical linkage includes a pivot member having a first end and a second end, the first end attached to the pressure plate at a first pivot point, the pivot member configured to rotate about a fixed pivot point, the fixed pivot point located between the first end and the second end, the fixed pivot point having a fixed position relative to the housing.

In addition to one or more of the features described herein, the mechanical linkage includes a linking member having a third end and a fourth end, the third end connected to the second end by a second pivot point, the fourth end moveable in the lateral direction.

In addition to one or more of the features described herein, the system includes a bias control device configured to be operated to adjust the biasing force of the biasing member.

In addition to one or more of the features described herein, the bias control device includes a pinion gear coupled to a linear gear, the pinion gear connected to an actuator, the actuator configured to rotate the pinion gear to adjust the biasing force.

In another exemplary embodiment, a method of controlling a pressure of a battery cell includes receiving an expansion force at a pressure plate disposed at an initial position relative to the battery cell, the battery cell disposed in a housing, the expansion force resulting from expansion of the battery cell, and managing a pressure of the battery cell by a pressure management system including a mechanical linkage attached to the pressure plate and a biasing system including a biasing member. Managing the pressure includes translating the expansion force to a reactive force based on a lateral movement of the mechanical linkage in a lateral direction, the reactive force configured to oppose the expansion force, and controlling the reactive force based on resisting the lateral movement of the mechanical linkage by the biasing system. The biasing system applies a biasing force via the biasing member in a direction opposite the lateral direction, the biasing force causing the mechanical linkage to apply the reactive force as a selected proportion of the expansion force.

In addition to one or more of the features described herein, the pressure management system includes a stop component configured to restrict the lateral movement of the mechanical linkage, the reactive force generated based on the stop component causing a portion of a lateral force generated by the mechanical linkage to be directed toward the battery cell.

In addition to one or more of the features described herein, the biasing member is a spring having a first end configured to engage the mechanical linkage and a second end connected to the stop component.

In addition to one or more of the features described herein, the mechanical linkage includes a pivot member having a first end and a second end, the first end attached to the pressure plate at a first pivot point, the pivot member configured to rotate about a fixed pivot point, the fixed pivot point located between the first end and the second end, the fixed pivot point having a fixed position relative to the housing.

In addition to one or more of the features described herein, the mechanical linkage includes a linking member having a third end and a fourth end, the third end connected to the second end by a second pivot point, the fourth end moveable in the lateral direction.

In addition to one or more of the features described herein, the method includes adjusting the biasing force of the biasing member by operating a bias control device.

In addition to one or more of the features described herein, the bias control device includes a pinion gear coupled to a linear gear, the pinion gear connected to an actuator, and controlling the reactive force includes controlling the actuator to rotate the pinion gear to adjust the biasing force.

In yet another exemplary embodiment, a vehicle system includes a battery system connected to an electric motor of a vehicle, the battery system including a battery cell disposed in a housing, and a pressure management system including a pressure plate disposed at an initial position relative to the battery cell, where expansion of the battery cell causes an expansion force to be applied to the pressure plate. The pressure management system also includes a mechanical linkage attached to the pressure plate, the mechanical linkage configured to move in a lateral direction in response to the expansion force and translate the expansion force to a reactive force that is opposed to the expansion force, and a biasing system configured to resist a lateral movement of the mechanical linkage. The biasing system includes a biasing member configured to apply a biasing force in a direction opposite the lateral direction, the biasing force causing the mechanical linkage to apply the reactive force as a selected proportion of the expansion force.

In addition to one or more of the features described herein, the biasing member has a spring constant selected so that the biasing force causes the reactive force to be the selected proportion of the expansion force.

In addition to one or more of the features described herein, the pressure management system includes a stop component configured to restrict the lateral movement of the mechanical linkage, the reactive force generated based on the stop component causing a portion of a lateral force generated by the mechanical linkage to be directed toward the battery cell.

In addition to one or more of the features described herein, the biasing member is a spring having a first end configured to be coupled to the mechanical linkage, and a second end connected to the stop component.

In addition to one or more of the features described herein, the pressure management system includes a bias control device configured to be operated to adjust the biasing force of the biasing member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an energy storage system including a housing that holds one or more battery cells, and a pressure management system, in accordance with an exemplary embodiment;

FIGS. 2A and 2B depict an energy storage system including a pressure management system including one or more mechanical linkages and a biasing system, in accordance with an exemplary embodiment;

FIG. 3 schematically illustrates a pressure management system, in accordance with an exemplary embodiment;

FIG. 4 schematically illustrates a conventional pressure management system;

FIG. 5 is a graph that depicts parameters of the pressure management system of FIG. 3, in comparison with parameters of the conventional pressure management system of FIG. 4;

FIGS. 6A-6C are force diagrams depicting various forces generated during operation by a linking mechanism in cooperation with the biasing system of FIGS. 2A and 2B, in accordance with an exemplary embodiment;

FIGS. 7A and 7B depict an energy storage system including a pressure management system including one or more mechanical linkages and a biasing system including one or more tilted or inclined biasing members, in accordance with an exemplary embodiment;

FIGS. 8A and 8B depict an energy storage system including a pressure management system including one or more mechanical linkages and an adjustable biasing system, in accordance with an exemplary embodiment;

FIGS. 9A and 9B depict an adjustment device of the biasing system of FIGS. 8A and 8B, in accordance with an exemplary embodiment;

FIG. 10 is a flow diagram describing a method of managing pressure in a battery system, in accordance with an exemplary embodiment;

FIG. 11 depicts a motor vehicle including a battery system and a pressure management system, in accordance with an exemplary embodiment; and

FIG. 12 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for controlling pressure in battery assemblies and battery systems. An embodiment of a pressure management system includes a pressure plate disposed in a housing of a battery assembly (e.g., a battery pack or battery module), and moveable in response to an expansion force generated by expansion of a battery cell or cells in the housing. The pressure management system also includes one or more mechanical linkages that translate a portion of the expansion force into a reactive force or reverse force to maintain or achieve a desired pressure in the battery cell(s). In an embodiment, the pressure management system includes a biasing system that cooperates with the mechanical linkage(s) to generate the reverse force.

In an embodiment, a mechanical linkage includes a first elongated member (referred to as a “pivot member”) and a second elongated member (referred to as a “linking member”). The pivot member is attached, for example, at one end by a pivot to the pressure plate, and is attached at another end to an end of the linking member by another pivot. The pivot member is also attached to a fixed pivot attached to the housing. When an expansion force is applied to the pressure plate, movement of the pressure plate causes an end of the linking member to move laterally (i.e., along the pressure plate and/or in a direction orthogonal to the expansion force direction) toward a stop component. Upon the linking member engaging a stop component or other resistive component, lateral force applied by the linking member is translated to a reactive force or reverse force that is proportional to the expansion force.

In an embodiment, the pressure management system includes a biasing system that is selectable to control the reverse force (e.g., cause the reverse force to be a desired proportion of the expansion force). For example, the biasing system includes a laterally extended spring that is attached to the stop component. When the linking member moves a given distance, the linking member engages the spring, and the spring applies a spring force that opposes movement of the linking member. The magnitude of the spring force can be calibrated or adjusted, for example, by selecting a spring having an appropriate spring constant and/or by incorporating a spring adjuster that can be actuated to modify the spring force.

Embodiments described herein present numerous advantages and technical effects. The embodiments provide for an improved battery functionality by maintaining a constant force on battery cells over their lifetime, and thereby effectively controlling pressure and avoiding negative effects such as dendrite growth. In addition, embodiments provide effective pressure control that requires a smaller volume than existing systems.

Embodiments are advantageous compared to existing pressure compensation systems. For example, existing systems can employ a spring that opposes expansion forces; however, such systems require significant increases in volume needed for battery modules or housings to accommodate springs with sufficient spring force to maintain desired pressures. Embodiments are able to provide effective pressure management with a relatively small volume.

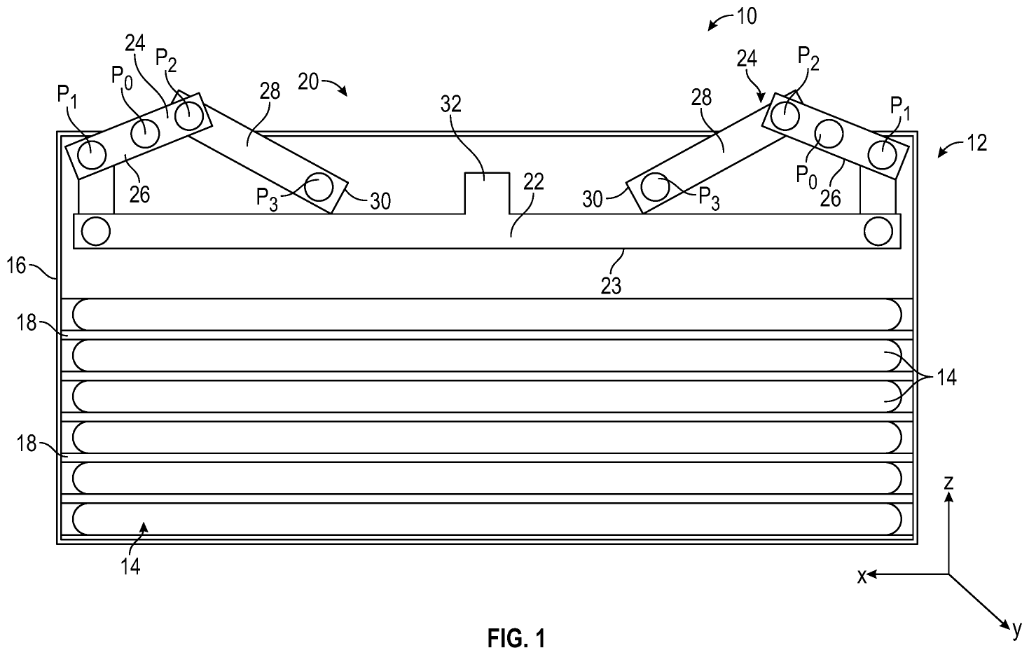

FIG. 1 depicts an embodiment of an energy storage device or system 10, which includes a battery module 12 that houses a set (i.e., one or more) of battery cells 14. Each battery cell 14 may be any type of cell that is rechargeable, such as a lithium-based cell (e.g., lithium-ion, lithium metal (LMB), etc.). For example, each cell 14 is a pouch-type lithium-ion cell.

The module 12 includes a housing 16 in which one or more battery cells 14 are disposed. If multiple cells are housed, they may be stacked as shown, in which adjacent cells 12 are separated by a support plate 18. It is noted that embodiments described herein are not limited to the type or dimensions of the housing 16, the type, dimensions or number of cells shown, or the type of cells shown.

The battery module 12 includes or is coupled to a pressure management system 20 configured to provide automatic management of pressure in the cells 14. The pressure management system 20 includes a pressure plate 22 disposed above the cells 14. The pressure plate 22 has a default position, which may be a position in which the pressure plate 22 contacts a cell 14 (e.g., rests on the uppermost cell 14). Alternatively, as shown in FIG. 1, the default position defines a separation or gap that allows for some amount of cell expansion before pressure compensation or management is triggered. It is noted that the pressure plate 22 can be disposed at any position or location (e.g., below the battery cells 14) such that expansion of the battery cells cause movement of the pressure plate 22.

A pressure compensation device is disposed on or otherwise connected to the pressure plate 22, and is configured to apply a reactive force on the pressure plate to compensate for expansion of the cells 14 and maintain the cells 14 at a desired pressure (or within a desired pressure range).

The pressure compensation device includes a set (i.e., one or more) of mechanical linkages 24 that translate a force on the pressure plate 22 to a reverse force (i.e., in a direction that opposes the expansion force). For example, as the cells 14 expand and exert an upward force on the pressure plate, the mechanical linkages 24 operate to exert a proportional downward force. Each linkage 24 can be calibrated to provide a downward force that maintains a constant selected pressure on the cells as they expand.

As shown in FIG. 1, the pressure compensation device includes two linkages 24 at opposing ends of the pressure plate 22. The pressure plate 22 is oriented so that a surface 23 facing the cells 14 defines a plane that is orthogonal to a direction of expansion. For example, the direction of expansion is along a z-axis (i.e., in a z-direction), and the surface is parallel to a plane defined by an x-axis and a y-axis.

Each mechanical linkage 24 includes a first member 26 (“pivot member”) that is positioned relative to the housing 16 at a fixed pivot point P0 (i.e., a pivot point that has a fixed position relative to the housing 16) about which the pivot member 26 can rotate. One end of the pivot member 26 is attached to the pressure plate 22 at a pivot point P1, such that the pivot member 26 is rotatable about the pivot point P1. Another end of the pivot member 26 is attached to an end of a linking member 28 at a pivot point P2.

An opposing end of the linking member 28 is coupled to the pressure plate 22, such that when a force due to expansion (referred to as an “expansion force” denoted by Fₑ) exceeds some threshold force Fₜ, the expansion force Fₑ pushes the pressure plate 22 upward (in the z-direction). This causes the pivot member 26 to rotate about the pivot point P0. Rotation of the pivot member 26 in turn causes an end 30 of the linking member 28 to move laterally (e.g., in the x-direction) or apply a lateral force toward a center of the pressure plate 22. A “lateral” direction may be a direction (e.g., in the x-y plane) orthogonal to a direction of the expansion force or a direction along a surface of the pressure plate 22.

The pressure plate 22 includes or is attached to a stop component 32, which may be a raised structure that counteracts lateral movement of the linking members 28. When a linking member 28 engages the stop component 32, the counteracting lateral forces cause a reactive force (also referred to as a “reverse force” denoted by Fᵣ) to be applied to the cell 14. The reverse force Fᵣ is proportional to the expansion force Fₑ. Parameters of the mechanical linkages 24 may be selected to calibrate the mechanical linkages 24 to achieve a desired proportionality of the reverse force. Examples of such parameters include the lengths of the pivot member 26 and the linking member 28, a height of the pivot point P1, a location of the pivot point P2, a location of the stop component 32 and others. As discussed further herein, parameters of a biasing system may also be selected or adjusted to calibrate the pressure management system 20.

The pressure management system 20, in an embodiment, includes a biasing system that provides one or more components configured to control the amount of reverse force Fᵣ (i.e., control a proportion of the expansion force Fₑ that is redirected toward the cell 14). The biasing system may be a passive or active system that can be designed so as to maintain and/or adjust a desired proportion.

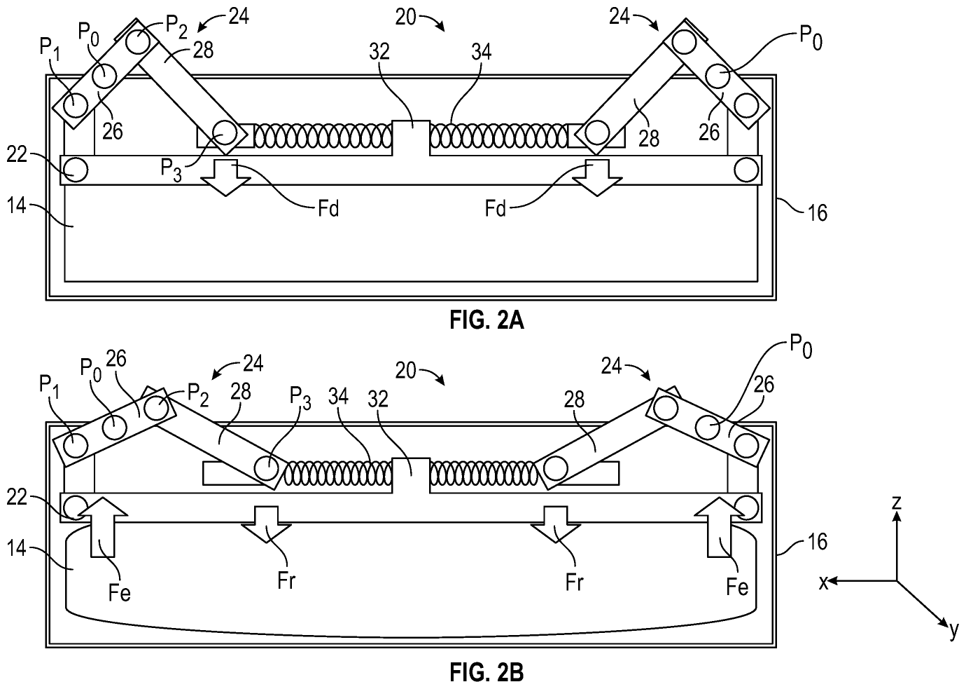

FIGS. 2A and 2B show an embodiment of the pressure management system 20, in which the system is a passive system. In this embodiment, the pressure management system 20 includes a laterally extending spring 34 that is configured to resist lateral movement of each linking member 28. Each spring 34 exerts a biasing force that opposes the lateral movement. FIG. 2A shows the pressure plate in an initial or default position, at which a default reverse force Fa is exerted on the cell 14.

As shown, each spring 34 is connected to, or attached to, the stop component 32 at one end of the spring 34. Another end of each spring 34 is located laterally away from the stop component 32, and is configured to engage with a respective linking member 28.

The biasing force is a function of a spring constant k of the spring 34. When the cell 14 expands and applies an expansion force Fₑ to the pressure plate 22, upward movement of the pressure plate 22 causes each pivot member 26 to rotate about a respective fixed pivot point P0, which in turn causes each linking member 28 to move laterally. This lateral movement applies a lateral force on the spring 34 (e.g., by end of the linking member that is at or near a point P3) and compresses the spring, as shown in FIG. 2B. The spring 34 exerts an opposing biasing force (also referred to as a “spring force”), which is dependent on the spring constant k.

By selecting an appropriate spring constant k, the magnitude of the reverse force Fᵣ can be set as a selected proportion of the expansion force Fₑ. For example, a spring with a higher spring constant (and higher stiffness) corresponds to a higher proportion, and a spring with a lower spring constant corresponds to a lower proportion.

It is noted that embodiments are not limited to the number and location of the mechanical linkages described herein. For example, the pressure management system 20 may include one linkage 24 on one side of the pressure plate 22. In addition, there may be more than one linkage 24 arrayed along the y-direction.

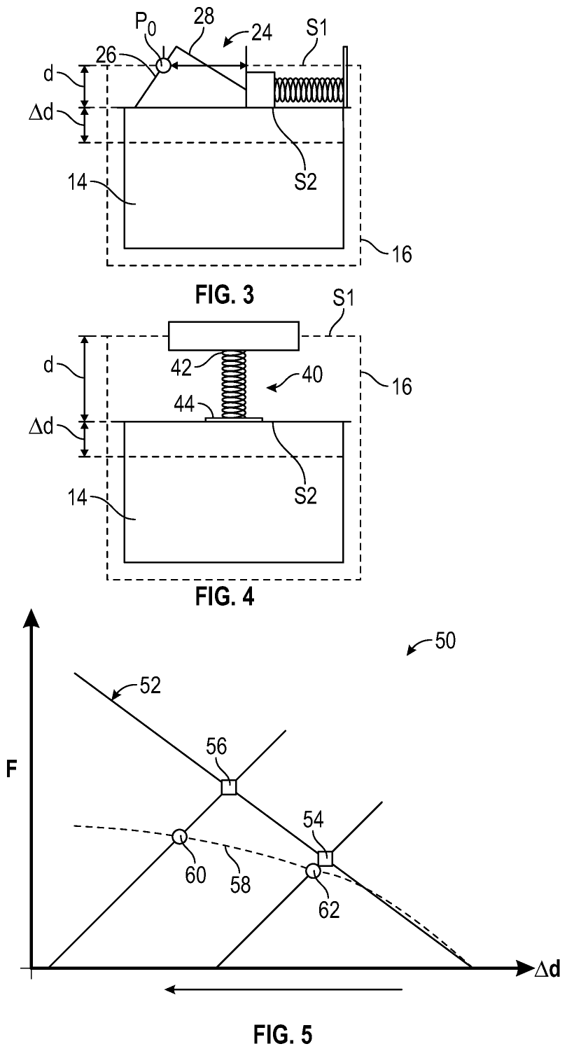

FIGS. 3 and 4 depict aspects of a pressure management system as described herein, and aspects of a conventional system. FIG. 5 illustrates a comparison between characteristics of embodiments described herein and a conventional system.

Aspects of the battery cell 14, in conjunction with a mechanical linkage 24 and a lateral spring 34, are shown schematically in FIG. 3. For comparison, an example of a conventional system is shown in FIG. 4, which includes a vertically oriented spring 40 having a fixed end 42 attached to the housing 16 and a moveable end 44 that exerts a vertical spring force on the cell 14. The lateral spring 34 and the spring 40 have the same spring constant.

In FIGS. 3 and 4, a distance d is defined between a surface S2 of the cell 14 and an upper surface S1 of the housing 16 when the cell is at 100% state of charge (SOC) and is fully expanded. As the SOC lowers, the surface of the cell recedes, increasing the overall distance between the cell surface and the upper surface by a distance Δd. At 100% SOC, and as the SOC decreases, Δd decreases toward zero.

FIG. 5 shows a graph 50 of force F as a function of Δd. In the graph 50, Δd is at a maximum at the graph origin, and reduces to zero as the cell 14 expands. A curve 52 shows the spring force of the vertical spring 40, which increases linearly as a function of Δd. A point 54 represents an equilibrium between the spring force and the expansion force at 0% SOC, and a point 56 represents the equilibrium at 100% SOC.

FIG. 5 also includes a curve 58 representing the spring force from the spring 34 of an embodiment of the pressure management system 20. A point 60 represents an equilibrium between the spring force and the expansion force at 0% SOC, and a point 62 represents the equilibrium at 100% SOC. The shape of the curve 58 is affected by the spring constant and design of the linking mechanism.

Thus, the pressure management system 20 can effectively maintain a constant pressure with a smaller volume due to the laterally extending spring 34 and the mechanical linkage 24.

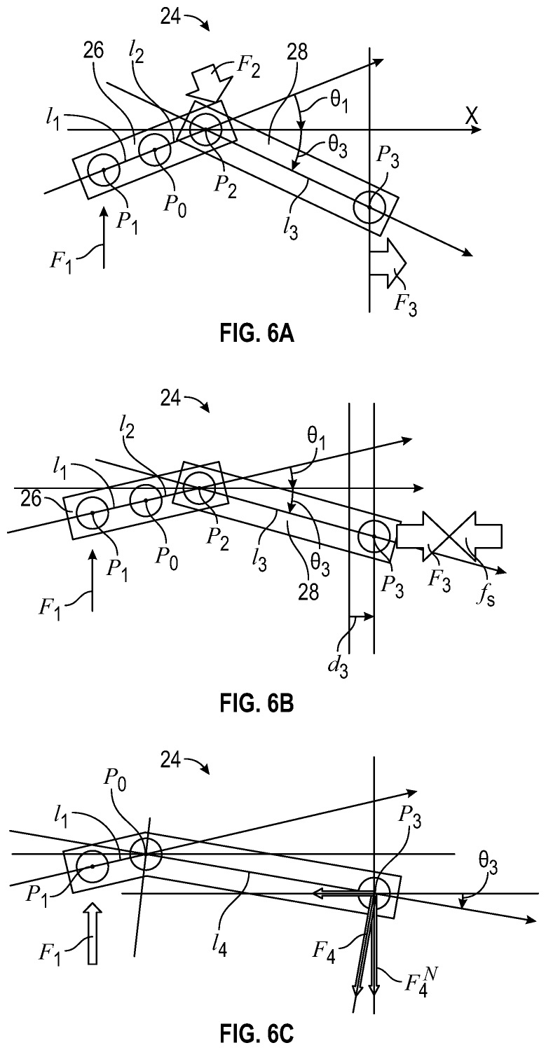

FIGS. 6A-6C are force diagrams depicting aspects of force transfer using a mechanical linkage 24 and a biasing member such as the spring 34. FIGS. 6A-6C also illustrate aspects of calculation of forces and selection of spring properties to achieve a desired reverse force.

In these diagrams, l₁ is a length in the x-z plane from pivot point P1 to pivot point P0, l₂ is a length from pivot point P0 to pivot point P2, and l₃ is a length from pivot point P2 to pivot point P3. The pivot member 26 defines an angle θ₁ with respect to the x-axis (or a direction of lateral movement of the end 30), and the linking member 28 defines an angle θ₃ with respect to the x-axis.

As shown in FIG. 6A, when a force F₁ (the expansion force) is applied vertically (in the z-direction or parallel to the direction of expansion) to the pressure plate 22, the pivot member 26 rotates about the pivot point P0, causing a force F₂ on the linking member 28, which in turn causes the linking member 28 to move in the x-direction and generate a lateral force F₃.

As shown in FIG. 6B, the linking member 28 pushes against the spring 34, which causes the spring 34 to apply an opposing spring force fₛ. The spring force fₛ is proportional to a distance d₃, which is a lateral distance that point P3 moves as a result of the expansion force. The spring 34 has a spring constant k, and the spring force fₛ is k multiplied by d₃ (fₛ=k*d₃)

When the linking mechanism 24 is in a steady state condition, the linking mechanism 24 does not move. The pivot member 26 and the linking member 28 can be considered a rigid body with a fulcrum at point P0, as illustrated in FIG. 6C. In this condition, the linking mechanism 24 exerts a force F₄. The force F₄ has a normal component F₄^{N}, which represents the reverse force that is applied to the battery cell 14.

In the steady state condition, the total torque is zero and thus can be represented by:

$${l}_{1} {F}_{1} + {l}_{4} {F}_{4} = 0 ,$$

where l₄ is a length from point P0 to P3 (FIG. 6C). Accordingly,

$${F}_{4} = - \frac{{l}_{1}}{{l}_{4}} {F}_{1} .$$

The normal component F₄^{N}, i.e., the reverse force can be calculated based on:

$${F}_{4}^{N} = {F}_{4} cos {θ}_{3} = - \frac{{l}_{1}}{{l}_{4}} {F}_{1} cos {θ}_{3} .$$

The length l₄ varies as a function of d₃ and the spring force fₛ. Accordingly, the length l₄ and the angle θ₃ are a function of k. Thus, k can be selected to calibrate the pressure management system 20 and produce a reactive force that has a desired proportion of the expansion force.

In addition to the spring constant k, other aspects of the pressure management system 20 can be selected or designed to control the reverse force. For example, the lengths of the pivot member 26 and the linking member 28, as well as positions of the pivot points P0 and P1, can be varied to affect the reverse force.

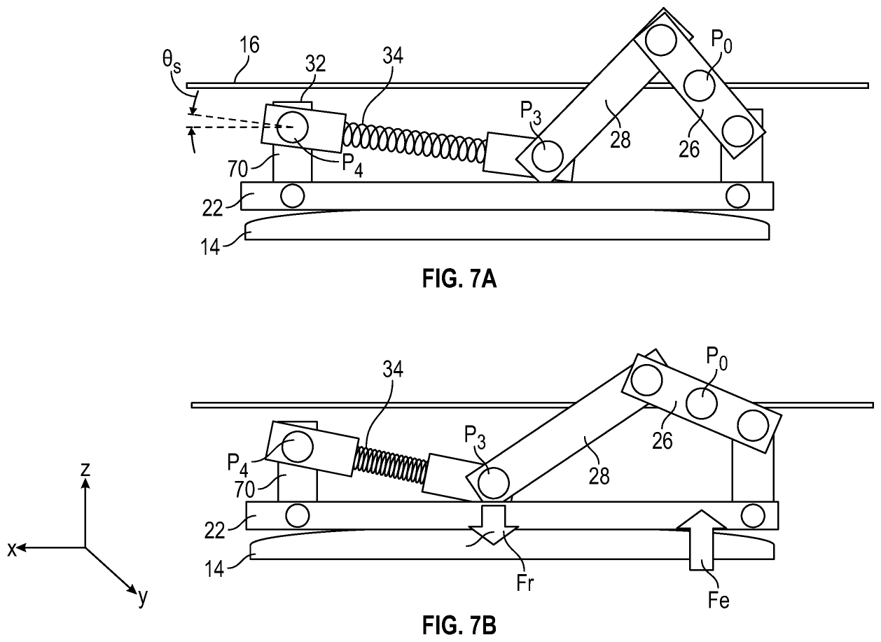

FIGS. 7A and 7B depict an example of a design feature that can be selected, in combination with other features such as spring constant, to achieve desired reverse forces. FIG. 7A shows the pressure plate 22 in an initial or default position, at which a default reverse force Fᵣ is exerted on the cell 14. FIG. 7B shows the pressure management system 20 when the cell 14 has expanded, causing the linking member 28 to move laterally and compress the spring 34.

In this example, the spring 34 is configured in a tilted configuration, in which the spring 34 defines an initial angle θ, with respect to a surface of the pressure plate 22. The angle θ, can be designed to affect the amount of spring force fₛ produced and thereby affect the reverse force magnitude and the proportion of the expansion force Fₑ that corresponds to the reverse force.

The angle θ, may be established as shown in FIGS. 7A and 7B, by attaching an end of the spring 34 to a support structure 70. The end can be attached so that the spring 34 can stay linear by rotating about a pivot point P4. Features such as the height of the support structure 70 (e.g., in the z-direction) and the pivot point P4 can be selected to define the angle and corresponding spring force.

In an embodiment, the pressure management system 20 is configured to be adjustable in order to change the proportionality of the reverse force Fᵣ with respect to the expansion force Fₑ. The pressure management system 20 may include a biasing control system that can be actively controlled at any time to change the relationship between expansion and reverse forces, and thereby control the pressure in a battery cell or cells.

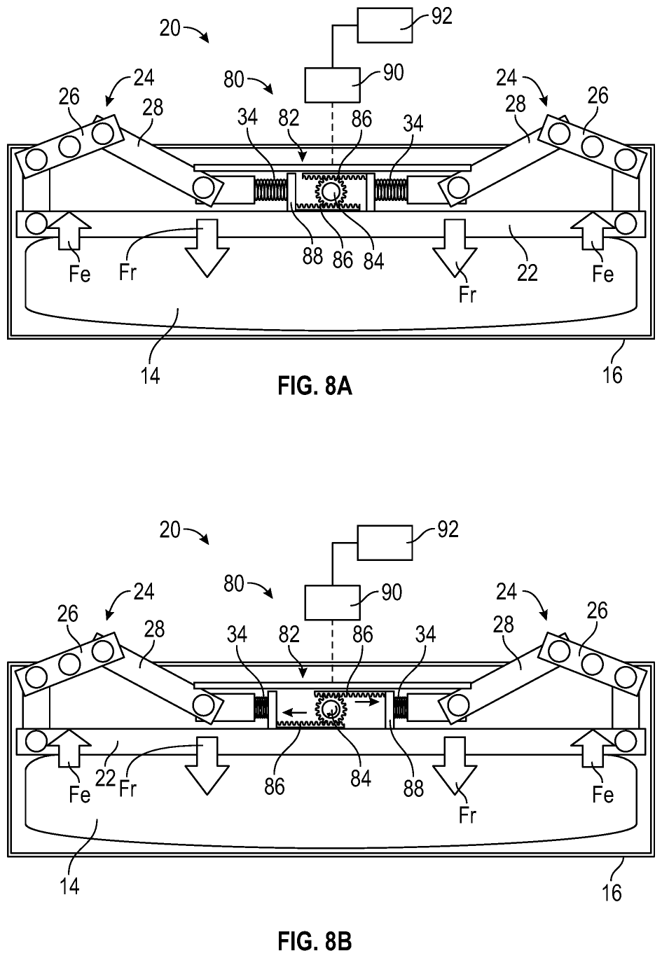

FIGS. 8A and 8B depict an embodiment of the pressure management system 20 including a biasing member adjustment system 80. The adjustment system includes an adjustment device, referred to as a spring adjuster 82. The spring adjuster 82 is coupled to the springs 34 and is controllable to increase or decrease spring compression, and thereby control the spring force (i.e., the magnitude of the spring force due to a given amount of lateral movement).

In an embodiment, the spring adjuster 82 includes a stationary pinion gear 84 that is coupled to at least one linear gear or rack 86 (or other linear actuator). Each linear gear 86 is attached to or otherwise engageable with a respective spring 34 to adjust the spring force fₛ. For example, each linear gear 86 is attached at an end thereof to an interface component 88 (e.g., a plate or disc) that engages the spring 34.

The pinion gear 84 is coupled to an actuator 90, such as a low power motor, which is operable to rotate the pinion gear 84 to move the linear gears 86 and compress or decompress the springs 34. The actuator 90 may be manually controlled by an operator, or controlled via a controller 92 or other processing device.

FIG. 8A shows a condition in which the cell 14 has expanded and is exerting an expansion force Fₑ on the pressure plate 22. As discussed above, each mechanical linkage 24, in conjunction with a spring 34 or other biasing device, redirects the expansion force Fₑ and applies a reverse force Fᵣ on the cell 14. In this condition, the reverse force Fᵣ has a first magnitude.

If it is desired to adjust the reverse force (e.g., to maintain a constant pressure as conditions such as temperature change, or to change the pressure), the pinion gear 84 is controlled to rotate the pinion gear 84 and cause the linear gears 86 to move. The pinion gear 84 may be rotated in a clockwise direction to move the linear gears 86 outwardly and compress the springs 34, which increases the reverse force relative to a given expansion force (shown in FIG. 8B). To decompress the springs 34 and thereby reduce the reverse force, the pinion gear 84 may be rotated in a clockwise direction.

Embodiments are not limited to the configuration shown in FIGS. 8A and 8B. Embodiments may include multiple spring force adjusters that are controlled synchronously by a single motor. In other embodiments, multiple independent spring force adjusters are provided, in which each spring force adjuster is independently controlled.

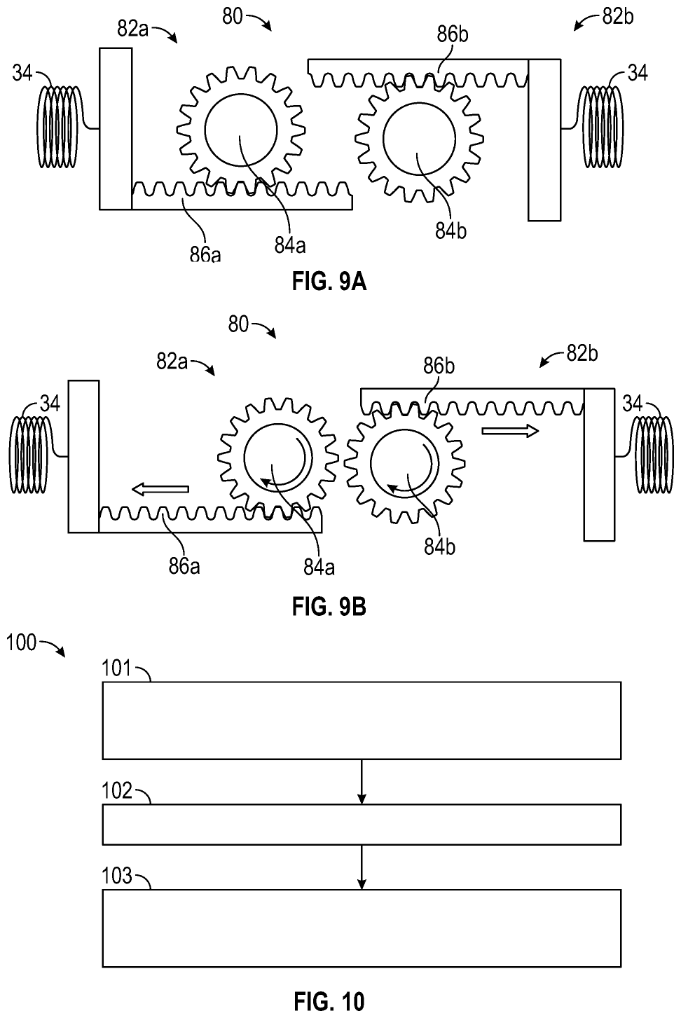

FIGS. 9A and 9B show an example in which the adjustment system 80 includes two independently controllable spring adjusters 82a and 82b. Each spring adjuster is coupled to a different spring 34 or biasing device, and has its own motor. FIG. 9A shows the biasing system in a first state in which compression on the springs 34 is relatively low, and FIG. 9B shows a condition in which the spring adjusters 82a and 82b are both actuated to compress their respective springs 34. As each spring adjuster is independently controllable, a different amount of compression can be applied (e.g., the spring adjusters 82a and 82b are controlled so that one of the springs 34 has a different compression than an opposing spring 34).

FIG. 10 illustrates an embodiment of a method 100 of managing pressure of a battery assembly. Aspects of the method 100, such as adjustment of a biasing system, may be performed by a processor or processors.

The method 100 includes a number of steps or stages represented by blocks 101-103. The method 100 is not limited to the number or order of steps therein, as some steps represented by blocks 101-103 may be performed in a different order than that described below, or fewer than all of the steps may be performed.

Aspects of the method 100 are discussed in conjunction with the pressure management system 20 as shown in FIGS. 2A and 2B, for illustration purposes. The method 100 is not so limited and can be used with any type of battery cell and any system having linkages that reverse forces as described herein.

At block 101, a battery assembly is assembled or manufactured. The battery assembly may be a battery module, such as the module 12, having one or more battery cells. Such cells may be lithium metal type pouch cells or any other cells that are subject to expansion. Manufacture of the battery assembly includes disposing a pressure management system, such as the pressure management system 20 of FIGS. 2A and 2B in the battery assembly.

At block 92, the battery assembly is operated. For example, the battery module 12 is a battery pack of a vehicle, and provides electrical power to an electric motor or motors of the vehicle.

At block 93, as the one or more battery cells expand during operation (or between operations), the pressure management system controls the pressure of the battery cell or cells of the battery assembly. This control includes applying a proportional reverse force in a direction toward the battery cell(s) to compensate for an expansion force and maintain a desired pressure or pressure range. For example, when the battery cells 14 expand, the mechanical linkages 24 and the springs 34 redirect a portion of an expansion force Fₑ as a reverse force Fᵣ.

In an embodiment, the pressure management system is a passive system that automatically reacts and applies a reverse force that is affected by the spring constant or stiffness of the biasing system. In another embodiment, if a spring adjuster is included, the control includes operating an actuator to adjust the spring force that is applied in response to movement of a linking mechanism.

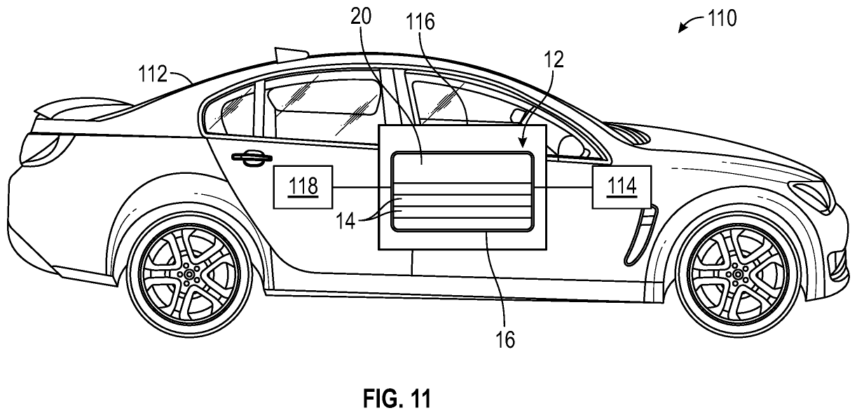

As noted herein, the pressure management system may be connected to, or part of a vehicle battery system. FIG. 11 shows an embodiment of a motor vehicle 110, which includes a vehicle body 112. The vehicle 110 may be a combustion engine vehicle, an electrically powered vehicle (EV) or a hybrid electric vehicle (HEV). In an example, the vehicle 110 is a hybrid or electric vehicle having an electric motor 114. A battery system 116 is electrically connected to the motor 114 and/or other components, such as vehicle electronics. The battery system 116 includes one or more modules 12, and each module 12 defines or is part of a high voltage battery pack.

The vehicle 110 also includes one or more processing devices, such as a controller 118. The controller 118 may perform various functions, such as controlling conversion devices (e.g., one or more inverters and/or one or more direct current (DC)-DC converters), controlling components of the battery management system (e.g., the spring adjuster 82), and/or monitoring the motor 114 and/or battery system 116, and others. The controller 118 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 118 may include a non-transitory computer-readable medium that stores instructions which, when processed by one or more processors of the controller 118, implements methods of operating vehicle components and systems as desired.

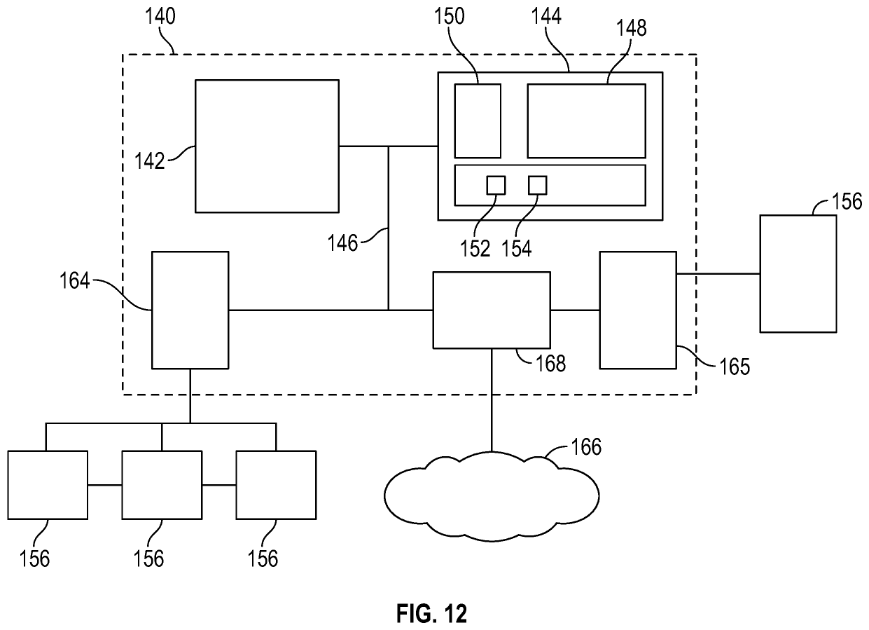

FIG. 12 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to monitoring battery systems. An image analysis module 154 may be included for controlling aspects of pressure management, such as controlling the actuator of the spring adjuster as described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this invention belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A pressure management system comprising:
a pressure plate disposed at an initial position relative to a battery cell, the battery cell disposed in a housing, wherein expansion of the battery cell causes an expansion force to be applied to the pressure plate;
a mechanical linkage attached to the pressure plate, the mechanical linkage configured to move in a lateral direction in response to the expansion force and translate the expansion force to a reactive force that is opposed to the expansion force; and
a biasing system including a biasing member configured to resist a lateral movement of the mechanical linkage, the biasing system configured to apply a biasing force in a direction opposite the lateral direction, the biasing force causing the mechanical linkage to apply the reactive force as a selected proportion of the expansion force.

2. The system of claim 1, wherein the biasing member has a spring constant selected so that the biasing force causes the reactive force to be the selected proportion of the expansion force.

3. The system of claim 1, further comprising a stop component configured to restrict the lateral movement of the mechanical linkage, the reactive force generated based on the stop component causing a portion of a lateral force generated by the mechanical linkage to be directed toward the battery cell.

4. The system of claim 3, wherein the biasing member is a spring having a first end configured to be coupled to the mechanical linkage, and a second end connected to the stop component.

5. The system of claim 1, wherein the mechanical linkage includes a pivot member having a first end and a second end, the first end attached to the pressure plate at a first pivot point, the pivot member configured to rotate about a fixed pivot point, the fixed pivot point located between the first end and the second end, the fixed pivot point having a fixed position relative to the housing.

6. The system of claim 5, wherein the mechanical linkage includes a linking member having a third end and a fourth end, the third end connected to the second end by a second pivot point, the fourth end moveable in the lateral direction.

7. The system of claim 1, further comprising a bias control device configured to be operated to adjust the biasing force of the biasing member.

8. The system of claim 7, wherein the bias control device includes a pinion gear coupled to a linear gear, the pinion gear connected to an actuator, the actuator configured to rotate the pinion gear to adjust the biasing force.

9. A method of controlling a pressure of a battery cell, comprising:
receiving an expansion force at a pressure plate disposed at an initial position relative to the battery cell, the battery cell disposed in a housing, the expansion force resulting from expansion of the battery cell; and
managing a pressure of the battery cell by a pressure management system including a mechanical linkage attached to the pressure plate and a biasing system including a biasing member, wherein managing the pressure includes:
translating the expansion force to a reactive force based on a lateral movement of the mechanical linkage in a lateral direction, the reactive force configured to oppose the expansion force; and
controlling the reactive force based on resisting the lateral movement of the mechanical linkage by the biasing system, the biasing system applying a biasing force via the biasing member in a direction opposite the lateral direction, the biasing force causing the mechanical linkage to apply the reactive force as a selected proportion of the expansion force.

10. The method of claim 9, wherein the pressure management system includes a stop component configured to restrict the lateral movement of the mechanical linkage, the reactive force generated based on the stop component causing a portion of a lateral force generated by the mechanical linkage to be directed toward the battery cell.

11. The method of claim 10, wherein the biasing member is a spring having a first end configured to engage the mechanical linkage and a second end connected to the stop component.

12. The method of claim 9, wherein the mechanical linkage includes a pivot member having a first end and a second end, the first end attached to the pressure plate at a first pivot point, the pivot member configured to rotate about a fixed pivot point, the fixed pivot point located between the first end and the second end, the fixed pivot point having a fixed position relative to the housing.

13. The method of claim 12, wherein the mechanical linkage includes a linking member having a third end and a fourth end, the third end connected to the second end by a second pivot point, the fourth end moveable in the lateral direction.

14. The method of claim 9, further comprising adjusting the biasing force of the biasing member by operating a bias control device.

15. The method of claim 14, wherein the bias control device includes a pinion gear coupled to a linear gear, the pinion gear connected to an actuator, and controlling the reactive force includes controlling the actuator to rotate the pinion gear to adjust the biasing force.

16. A vehicle system comprising:
a battery system connected to an electric motor of a vehicle, the battery system including a battery cell disposed in a housing; and
a pressure management system including:
a pressure plate disposed at an initial position relative to the battery cell, wherein expansion of the battery cell causes an expansion force to be applied to the pressure plate;
a mechanical linkage attached to the pressure plate, the mechanical linkage configured to move in a lateral direction in response to the expansion force and translate the expansion force to a reactive force that is opposed to the expansion force; and
a biasing system configured to resist a lateral movement of the mechanical linkage, the biasing system including a biasing member configured to apply a biasing force in a direction opposite the lateral direction, the biasing force causing the mechanical linkage to apply the reactive force as a selected proportion of the expansion force.

17. The vehicle system of claim 16, wherein the biasing member has a spring constant selected so that the biasing force causes the reactive force to be the selected proportion of the expansion force.

18. The vehicle system of claim 16, wherein the pressure management system includes a stop component configured to restrict the lateral movement of the mechanical linkage, the reactive force generated based on the stop component causing a portion of a lateral force generated by the mechanical linkage to be directed toward the battery cell.

19. The vehicle system of claim 18, wherein the biasing member is a spring having a first end configured to be coupled to the mechanical linkage, and a second end connected to the stop component.

20. The vehicle system of claim 16, wherein the pressure management system includes a bias control device configured to be operated to adjust the biasing force of the biasing member.
